(19) United States
(12) Patent Application Publication
(10) Pub. No.: US 2007/0203854 A1
(43) Pub. Date: Aug. 30, 2007

(54) Electronic contracting

(76) Inventors: Murali M. Karamchedu, Beaverton, OR (US); Jeffrey B. Sponaugle, Tigard, OR (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(21) Appl. No.: 11/365,748

(22) Filed: Feb. 28, 2006

(51) Int. Cl. H04L 9/00; H04K 1/00

(52) U.S. Cl. 705/80

(57) ABSTRACT

Embodiments of the present invention provide methods and systems for computer-facilitated construction of health care contracts.

### TECHNICAL FIELD

Embodiments of the present invention relate to the field of data processing, and, in particular, to methods and apparatuses for facilitating the creation of digital contracts, such as digital health care contracts.

### BACKGROUND

With advances in integrated circuit, microprocessor, networking, and communication technologies, an increasing number of devices, in particular, digital computing devices, are being interconnected. This increased interconnectivity of computing devices has laid the groundwork for a communication infrastructure particularly well suited for digital communications between such computing devices. More specifically, the increased interconnectivity of computing devices has led to the increased adoption of digital documents.

In the past, digital documents, including digital contracts were limited to digital reproductions of paper-based contracts. Over time, however, computer based applications have grown increasingly sophisticated enabling the formation (drafting), and analysis (including editing) of digital contracts.

### BRIEF DESCRIPTION OF THE DRAWINGS

Embodiments of the present invention will be readily understood by the following detailed description in conjunction with the accompanying drawings. To facilitate this description, like reference numerals designate like structural elements. Embodiments of the invention are illustrated by way of example and not by way of limitation in the figures of the accompanying drawings.

FIG. 1 illustrates a digital contract terms selection and assembly system in accordance with an embodiment of the present invention;

FIG. 2 illustrates a digital rates selection and assembly system in accordance with an embodiment of the present invention;

FIG. 3 illustrates a digital contract assembly system in accordance with an embodiment of the present invention;

FIG. 4 illustrates an exemplary computer system suitable for use as a contract formation system in accordance with an embodiment of the present invention; and

FIG. 5 illustrates a flowchart of a digital contract formation method in accordance with an embodiment of the present invention.

### DETAILED DESCRIPTION OF EMBODIMENTS OF THE INVENTION

In the following detailed description, reference is made to the accompanying drawings which form a part hereof wherein like numerals designate like parts throughout, and in which is shown by way of illustration embodiments in which the invention may be practiced. It is to be understood that other embodiments may be utilized and structural or logical changes may be made without departing from the scope of the present invention. Therefore, the following detailed description is not to be taken in a limiting sense, and the scope of embodiments in accordance with the present invention is defined by the appended claims and their equivalents.

The description is presented, in part, in terms of operations performed by a processor-based device, using terms such as selecting, assembling, receiving, determining, rendering, displaying, and the like, consistent with the manner employed by those skilled in the art. Quantities may take the form of electrical, magnetic, or optical signals capable of being stored, transferred, combined and/or otherwise manipulated through mechanical, electrical, and/or optical components of a processor-based device.

Various operations may be described as multiple discrete steps in turn, in a manner that may be helpful in understanding embodiments of the present invention; however, the order of description should not be construed to imply that these operations are order dependent.

For the purposes of the present invention, the phrase “A/B” means A or B. For the purposes of the present invention, the phrase “A and/or B” means “(A), (B), or (A and B)”. For the purposes of the present invention, the phrase “at least one of A, B, and C” means “(A), (B), (C), (A and B), (A and C), (B and C), or (A, B and C)”. For the purposes of the present invention, the phrase “(A)B” means “(B) or (AB)” that is, A is an optional element.

The description may use the phrases “in an embodiment,” or “in embodiments,” which may each refer to one or more of the same or different embodiments. Furthermore, the terms “comprising,” “including,” “having,” and the like, as used with respect to embodiments of the present invention, are synonymous.

In various embodiments of the invention, a method and apparatus for composing a digital contract is provided. In exemplary embodiments of the present invention, a computer system may be employed to facilitate contracting parties such as health care payers (e.g., “users”) in creating digital health care provider contracts. In the case of a digital health care contract, the digital contract may, for example, contain all of the provisions, conditions, and terms of operation of a pension or health or welfare plan. In the following description including the claims, unless further particularized or otherwise noted, the term “digital document” is intended to refer to a broad class of digital document types including but not limited to any file produced by a computer application embodying a contract, whether or not they comprise text, binary, or otherwise encoded form.

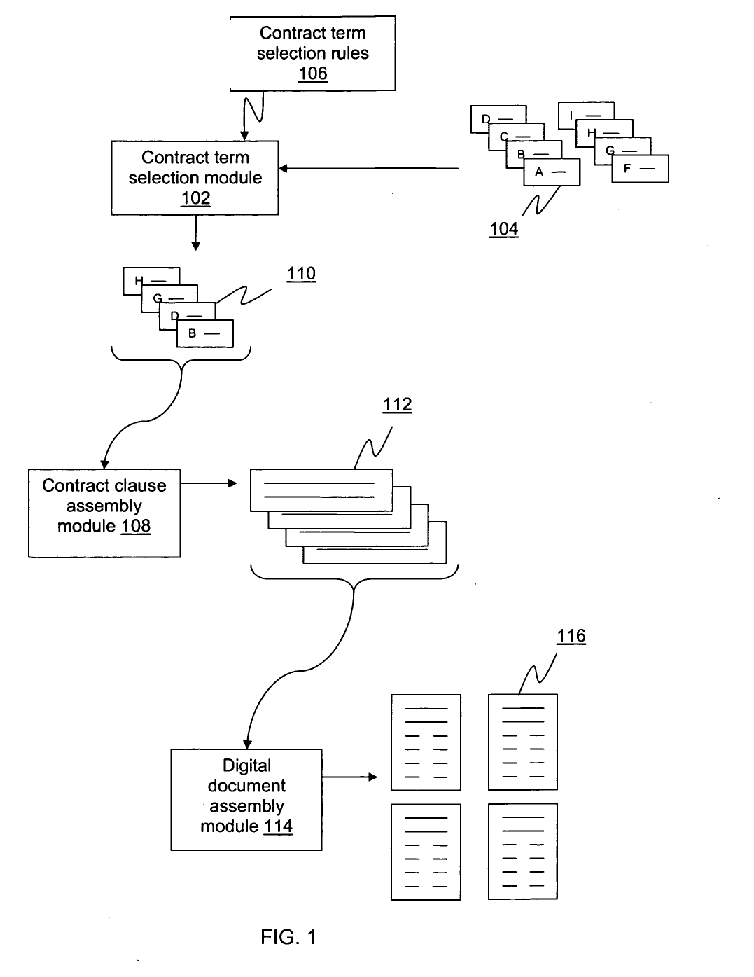

FIG. 1 is a diagram illustrating a system in accordance with an embodiment of the present invention. A contract term selection module 102 may be provided to facilitate the selection, for example, by a user, of one or more digital contract terms from a plurality of contract terms 104. In various embodiments of the present invention the plurality of digital contract terms may be stored in one or more databases. In such an embodiment, a suitable database may be a relational database. In various embodiments of the present invention, the term “contract term” is intended to refer to any word, phrase, or expression which relates to a particular matter. A contract term may, for example, have to do with amendments, expenses, representations, covenants, effective dates, restrictions, withdrawals, and the like. More specifically, in connection with a health care provider contract, a contract term may relate to payments, benefits, claims, exclusions, billings, authorizations, and the like.

In an embodiment of the present invention, contract term selection module 102 may be adapted to facilitate a user in selecting one or more digital contract terms in accordance with one or more digital contract term selection rules 106. Thus, the contract term selection rules 106 may, for example, require one or more digital contract terms to be selected or not selected based on a selection of one or more digital contract terms. In such an embodiment, the selection of one or more contract terms may be dependent on the selection and/or exclusion of other contract term or terms (e.g., a “dependency”). In various embodiments of the present invention the contract term selection rules 106 may be stored in one or more databases.

In various embodiment of the present invention, contract term selection module 102 may be adapted to automatically select one or more digital contract terms based on a user's selection of one or more other digital contract terms. In an embodiment of the present invention, contract term selection module 102 may apply contract term selection rules 106 to automatically select one or more digital contract terms.

In an embodiment of the present invention, contract clause assembly module 108 is equipped to facilitate the user in assembling selected digital contract terms 110 to form digital contract clauses 112. In various embodiments of the present invention, the term “contract clause” is intended to broadly refer to any separate section, distinct article, or provision of a contract. According to an embodiment of the present invention, the selected digital contract terms 110 may be selected by the user. In another embodiment of the present invention, the selected digital contract terms 110 may be automatically selected by contract term selection module 102. In embodiments of the present invention, contract clause assembly module 108 may be provided to assemble selected digital contract terms 110 to form the one or more digital contract clauses 112. Once digital contract clauses 112 are formed, digital document assembly module 114 may be provided to facilitate the user in assembling digital contract clauses 112 to form digital documents 116.

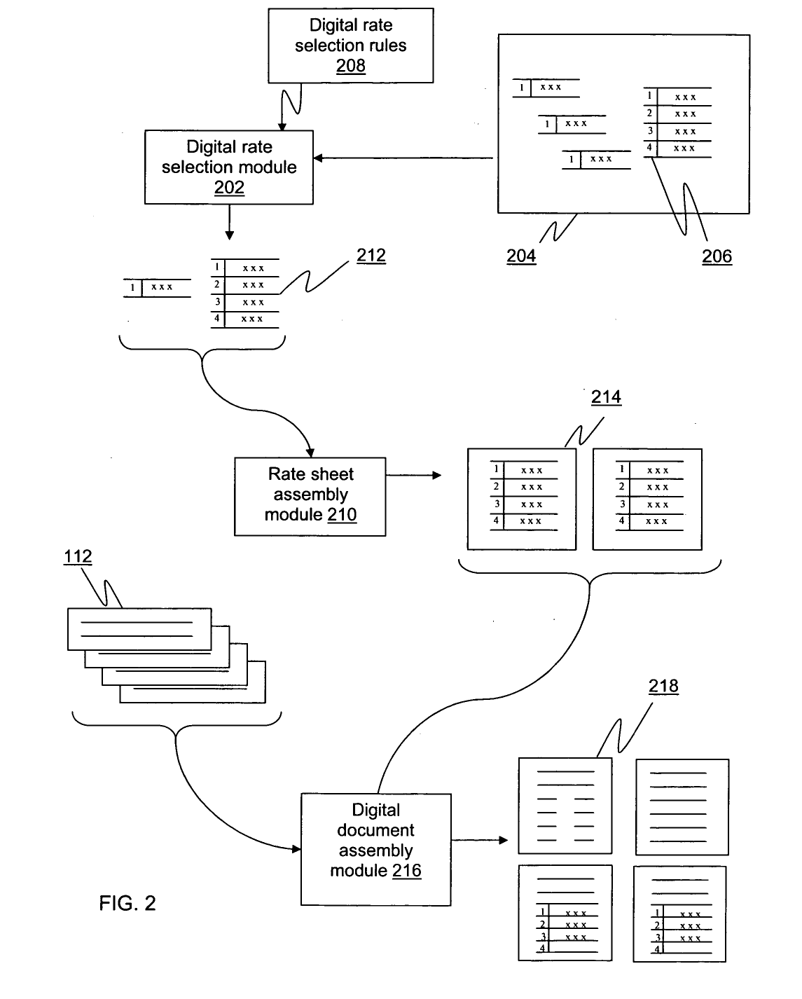

As shown in FIG. 2, in a further embodiment of the present invention, digital rate selection module 202 is provided to facilitate selecting one or more digital rates (i.e., “fees” or “premiums”) from a plurality of digital rates 204. In various embodiments of the present invention, the term “rate” is intended to broadly refer to any charge, payment, or price fixed according to a ratio, scale, or standard. More specifically, in such an embodiment, the term “rate” may broadly refer to an insurance rate. In various embodiments of the present invention, the digital rates may be organized into one or more rate spans 206. In various embodiments of the present invention, the term “rate span” is intended to broadly refer to any extent or measure between two rates, for example, as in a range or list. In accordance with another embodiment of the present invention, digital rate selection module 202 may be further adapted to facilitate a user in selecting one or more digital rates based at least in part on selected digital contract terms 110, in accordance with one or more digital rate selection rules 208. Digital rate selection rules 208 may, for example, require one or more digital contract rates to be selected or not selected, in view of selected digital contract terms 110. Thus, in exemplary embodiments of the present invention, a rate span 206 may be limited and/or constrained by selected digital contract terms 110. In an embodiment of the present invention digital rate selection rules 208 may be stored in one or more databases.

In an embodiment of the present invention, rate sheet assembly module 210 is provided to facilitate assembling selected digital rates 212 to form one or more digital rate sheets 214. In exemplary embodiments of the present invention, digital rate sheets 214 may list accepted fees or established allowances for specified medical procedures. For example, as used in medical care plans, digital rate sheets 214 may represent the maximum amounts a program will pay for specified procedures. In an embodiment of the present invention, digital document assembly module 216 may be provided to assemble the one or more digital contract clauses 112 and the one or more digital rate sheets 214 to form the one or more digital documents 218.

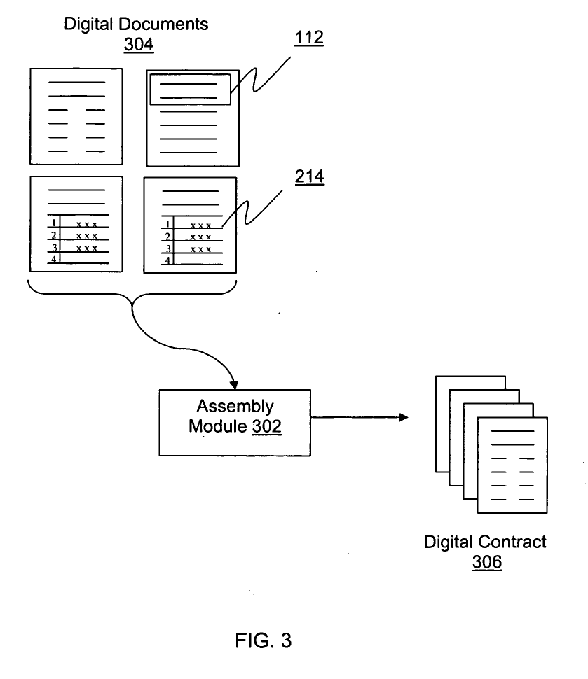

FIG. 3 illustrates a digital contract assembly system in accordance with an embodiment of the present invention. As shown, assembly module 302 may be provided to facilitate a user in assembling one or more digital documents 304 to form a digital contract 306. In various embodiments of the present invention digital documents 304 may include one or more digital rate sheets 214 and/or one or more digital contract clauses 112.

In an embodiment, a digital document may include one or more terms directly, independent of the one or more terms making up one or more clauses. In an embodiment of the present invention, a digital document may include at least one clause or term, wherein the clause may include at least one term. A document may include a rate sheet, which in turn includes at least one rate.

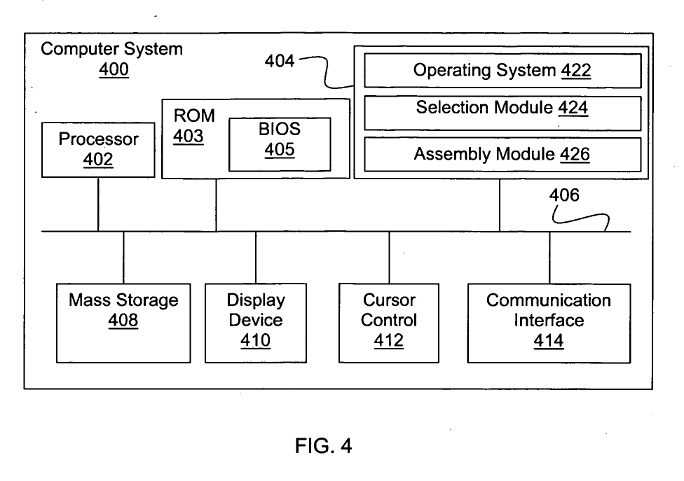

FIG. 4 illustrates an exemplary computer system in accordance with embodiments of the present invention. As shown, example computer system 400 includes processor 402, ROM 403 including basic input/output system (BIOS) 405, and system memory 404 coupled to each other via “bus” 406. Also coupled to “bus” 406 are nonvolatile mass storage 408, display device 410, cursor control device 412, and communication interface 414. During operation, memory 404 may also include working copies of operating system 422, selection module 424, and assembly module 426. In various embodiments, memory 404 may also include one or more applications (not shown), with which selection module 424 and assembly module 426 are coupled. In various embodiments of the present invention, selection module 424 may include contract term and contract rate selection logic in accordance with embodiments of the present invention to facilitate a user in selecting contract terms and contract rates for assembling into a digital contract. In various embodiments of the present invention, assembly module 426 may include contract term and contract rate assembly logic in accordance with embodiments of the present invention to facilitate a user in assembling contract terms and contract rates into digital documents. Assembly module 426 may be further adapted to assemble the digital documents into a digital contract. In other embodiments, computer system 400 may also include one or more databases for storing the digital contract terms and the digital contract rates.

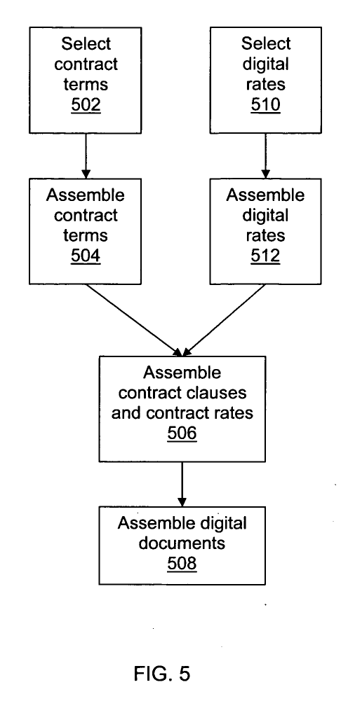

FIG. 5 illustrates a flowchart of a computer implemented method for composing a digital contract in accordance with an embodiment of the present invention. In block 502, one or more digital contract terms are selected from a plurality of digital contract terms. According to an embodiment of the present invention, the plurality of contract terms may be stored in a database of contract terms. In another embodiment of the present invention the selection of contract terms may be governed by selection rules. In such an embodiment, the selection rules may, for example, require one or more digital contract terms to be selected, or not selected, in view of the selection of one or more digital contract terms. In various embodiments, one or more digital contract terms may be automatically selected based on a user selection of one or more other digital contract terms.

In an embodiment of the present invention, the digital contract terms are assembled to form one or more digital contract clauses (block 504). In an embodiment, one or more digital contract terms may be directly included in a document absent formation into at least one clause.

In an embodiment, the digital contract clauses may be created by assembling user selected and automatically selected digital contract terms. Once the digital contract terms are assembled into digital contract clauses, the digital contract clauses may be assembled to form one or more digital documents (block 506). In a further embodiment of the present invention, the digital documents may then be assembled to form a digital contract (block 508). In one embodiment of the present invention, the digital contract may be a health care provider contract.

In another embodiment of the present invention, one or more digital contract rates are selected from a plurality of digital rates (block 510). According to an embodiment of the present invention, the plurality of digital rates may be stored in a database. In another embodiment of the present invention, the plurality of digital rates may be organized into one or more rate spans. In an embodiment of the present invention the selection of digital rates may be governed by digital rate selection rules. In such an embodiment, the selection rules may require one or more digital contract rates to be selected, or not selected, in view of the selection of one or more digital contract terms. Once contract rates have been selected, the user may assemble at least the user selected digital contract rates to form one or more digital rate sheets (block 512).

In another embodiment of the present invention, the digital contract clauses and the digital rate sheets may be assembled together to form one or more digital documents (block 506), which in turn may be assembled to form a digital contract.

Although certain embodiments have been illustrated and described herein for purposes of description of the preferred embodiment, it will be appreciated by those of ordinary skill in the art that a wide variety of alternate and/or equivalent embodiments or implementations calculated to achieve the same purposes may be substituted for the embodiments shown and described without departing from the scope of the present invention. Those with skill in the art will readily appreciate that embodiments in accordance with the present invention may be implemented in a very wide variety of ways. This application is intended to cover any adaptations or variations of the embodiments discussed herein. Therefore, it is manifestly intended that embodiments in accordance with the present invention be limited only by the claims and the equivalents thereof.

What is claimed is:

1. A computer implemented method for composing a digital contract, comprising:
facilitating a user, by a computing device, in selecting one or more digital contract terms from a plurality of digital contract terms;
assembling by a computing device at least one of the one or more digital contract terms to form one or more digital documents; and
assembling by a computing device at least one of the one or more digital documents to form the digital contract.

2. The method of claim 1, wherein the digital contract comprises a digital health plan provider contract.

3. The method of claim 1, wherein the method further comprises
assembling by a computing device at least one of the one or more user selected digital contract terms to form one or more digital contract clauses for assembly into the one or more digital documents.

4. The method of claim 1, wherein the method further comprises
facilitating a user, by a computing device, in selecting one or more digital rates from a plurality of digital rates; and
assembling by a computing device at least one of the user selected one or more digital rates to form one or more digital rate sheets.

5. The method of claim 4, wherein the plurality of digital rates comprises a digital span of rates.

6. The method of claim 4, wherein the method further comprises
assembling by a computing device at least one of the one or more user selected digital rate sheets for assembly into the one or more digital documents.

7. The method of claim 4, wherein said facilitating of a user in selecting one or more digital rates comprises facilitating a user, by a computing device, in selecting one or more digital rates based at least in part on the selected one or more digital contract terms, in accordance with one or more digital rate selection rules.

8. The method of claim 7, wherein at least one of the digital rate selection rules requires one or more digital rates to be selected or not selected, in view of the selected one or more digital contract terms.

9. The method of claim 1, wherein said facilitating of a user in selecting one or more digital contract terms comprises facilitating a user, by a computing device, in selecting one or more digital contract terms based at least in part on one or more digital contract term selection rules.

10. The method of claim 9, wherein at least one of the digital contract term selection rules requires one or more digital contract terms to be selected or not selected, in view of the selected one or more digital contract terms.

11. The method of claim 9, wherein at least one of said one or more digital contract term selection rules requires the user to select or not select one or more digital contract terms based on the selection of one or more other digital contract terms.

12. The method of claim 1, wherein the method further comprises automatically selecting by a computing device one or more digital contract terms based on the user selection of one or more other digital contract terms.

13. A computer implemented method for composing a digital contract, comprising:
facilitating a user, by a computing device, in selecting one or more digital rates from a plurality of digital rates;
assembling by a computing device at least one of the user selected one or more digital rates to form one or more digital rate sheets;
assembling by a computing device at least one of the one or more digital rate sheets to form one or more digital documents; and
assembling by a computing device at least one of the one or more digital documents to form the digital contract.

14. The method of claim 13, wherein the plurality of digital rates comprises a digital span of rates.

15. The method of claim 13, wherein said assembling of at least the digital rate sheets to form one or more digital documents comprises assembling by a computing device the one or more digital rate sheets and one or more digital contract clauses and/or one or more digital contract terms to form the one or more digital documents.

16. The method of claim 13, wherein said facilitating of a user in selecting one or more digital rates comprises facilitating a user, by a computing device, in selecting one or more digital rates based at least in part on one or more selected digital contract terms, in accordance with one or more digital rate selection rules.

17. The method of claim 16, wherein at least one of the digital rate selection rules requires one or more digital rates to be selected or not selected, in view of the selected one or more digital contract terms.

18. A system, comprising:
a processor;
a selection module operated by the processor to facilitate a user in selecting one or more digital contract terms from a plurality of digital contract terms; and
an assembly module operated by the processor to facilitate a user in assembling at least one of the one or more user selected digital contract terms to form one or more digital documents, and to facilitate a user in assembling at least one of the one or more digital documents to form the digital contract.

19. The system of claim 18, wherein the assembly module is further operated by the processor to facilitate a user in assembling at least one of the one or more digital contract terms to form one or more digital contract clauses for assembly into the one or more digital documents.

20. The system of claim 18, wherein the selection module is further operated by the processor to facilitate a user in selecting one or more digital rates from a plurality of digital rates and the assembly module is further operated by the processor to facilitate assembling at least one of the user selected one or more digital rates to form one or more digital rate sheets.

21. The system of claim 20, wherein the plurality of digital rates comprises a digital span of rates.

22. The system of claim 20, wherein the assembly module is further operated by the processor to facilitate a user in assembling at least one of the one or more digital rate sheets for assembly into the one or more digital documents.

23. The system of claim 20, wherein the selection module is further operated by the processor to facilitate a user in selecting one or more digital rates based at least in part on the selected one or more digital contract terms, in accordance with one or more digital rate selection rules.

24. The system of claim 23, wherein at least one of the digital rate selection rules requires one or more digital rates to be selected or not selected, in view of the selected one or more digital contract terms.

25. The system of claim 18, wherein the selection module is further operated by the processor to facilitate a user in selecting one or more digital contract terms based at least in part on the selected one or more digital contract terms, in accordance with one or more digital contract term selection rules.

26. The system of claim 25, wherein at least one of the digital contract term selection rules requires one or more digital contract terms to be selected or not selected, in view of the selected one or more digital contract terms.

27. The system of claim 18, wherein the selection module is further operated by the processor to automatically select one or more digital contract terms based on the user selection of one or more other digital contract terms.

28. A system, comprising:
a processor;
a selection module operated by the processor to facilitate a user in selecting one or more digital rates from a plurality of digital rates; and
an assembly module operated by the processor to facilitate a user in assembling at least one of the user selected digital rates to form one or more digital rate sheets, to facilitate a user in assembling at least one of the one or more digital rate sheets to form one or more digital documents, and to facilitate a user in assembling at least one of the one or more digital documents to form the digital contract.

29. The system of claim 28, wherein the plurality of digital rates comprises a digital span of rates.

30. The system of claim 28, wherein the assembly module is further operated by the processor to facilitate a user in assembling at least one of the one or more digital rate sheets and one or more digital contract clauses or one or more digital contract terms to form at least one of the one or more digital documents.

31. The system of claim 28, wherein the selection module is further operated by the processor to facilitate the user in selecting one or more digital rates based at least in part on one or more selected digital contract terms, in accordance with one or more digital rate selection rules.

32. The system of claim 31, wherein at least one of the digital rate selection rules requires one or more digital rates to be selected or not selected, in view of the selected one or more digital contract terms.
